(19) United States
(12) Patent Application Publication
(10) Pub. No.: US 2008/0013272 A1
(43) Pub. Date: Jan. 17, 2008

(54) Hard drive carrier

(75) Inventors: Mark M. Bailey, Burnet, TX (US); Timothy C. Dearborn, Lakeway, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/486,550

(22) Filed: Jul. 14, 2006

(51) Int. Cl. G06F 1/16

(52) U.S. Cl. 361/685

(57) ABSTRACT

A hard drive carrier is disclosed that includes a key on a guide rail of the carrier. The key has a gap portion and a raised portion. When a hard drive fits within the gap portion, it can be placed in the hard drive carrier in a forward position. When the hard drive does not fit within the gap portion, it can only be placed in the hard drive carrier in a rear position. The guide rail includes a set of alignment holes to accommodate the positioning of the hard drive in a forward position or a rear position.

### TECHNICAL FIELD

The present disclosure relates generally to computer systems and information handling systems, and, more particularly, to a hard drive carrier for a computer system or information handling system.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

An information handling system or computer system may include a hard drive that is coupled to the chassis of a computer or a drive bay. A hard drive is typically disposed on a carrier assembly, often referred to as a hard drive carrier, and the carrier assembly is inserted, via a guide rail system, into a bay in a computer chassis. The hard drive carrier serves as a protective housing for the hard drive and mechanically mates with a drive bay in a computer chassis.

### SUMMARY

In accordance with the present disclosure, a hard drive carrier is disclosed that includes a key on the top guide rail of the carrier. Depending on the size of the hard drive, the key prevents it from being placed in the hard drive carrier in a forward position. The top and bottom guide rails include a set of alignment holes to accommodate the positioning of the hard drive in a forward position or a rear position. The hard drive carrier disclosed herein includes a detachable interposer. The interposer includes tab keys for inserting the interposer into and removing the interposer from the hard drive carrier.

The hard drive carrier disclosed herein is technically advantageous because its physical design is able to accommodate various hard drives in the proper positions in the hard drive carrier. The ability of the hard drive carrier to selectively support a hard drive in two positions—a forward position and a rear position—allows a single carrier to be used for multiple hard drives, without problems associated with improper positioning of the hard drive within the hard drive carrier.

Another technical advantage is the provision of an interposer that can be coupled within the hard drive carrier through a pair of tabs in the interposer. The tabs of the interposer mate with slots in the hard drive carrier, allowing the interposer to be attached and detached from the hard drive carrier without tools or additional fixtures. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is an exploded perspective view of a hard drive carrier;

FIG. 2A is a perspective view of an assembled hard drive carrier;

FIG. 2B is a perspective view of a hard drive carrier and a hard drive in a rear position;

FIG. 2C is a perspective view of a hard drive carrier having an interposer, and a hard drive in a forward position;

FIG. 3A is a perspective view of a hard drive carrier;

FIG. 3B is a perspective view of a hard drive carrier and a hard drive in a rear position;

FIG. 4 is a perspective view of a top guide rail of a hard drive carrier; and

FIGS. 5A-5C are a series of perspective views concerning the assembly and disassembly of an interposer in a hard drive carrier.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a person computer, a network storage device, or any other suikeyle device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

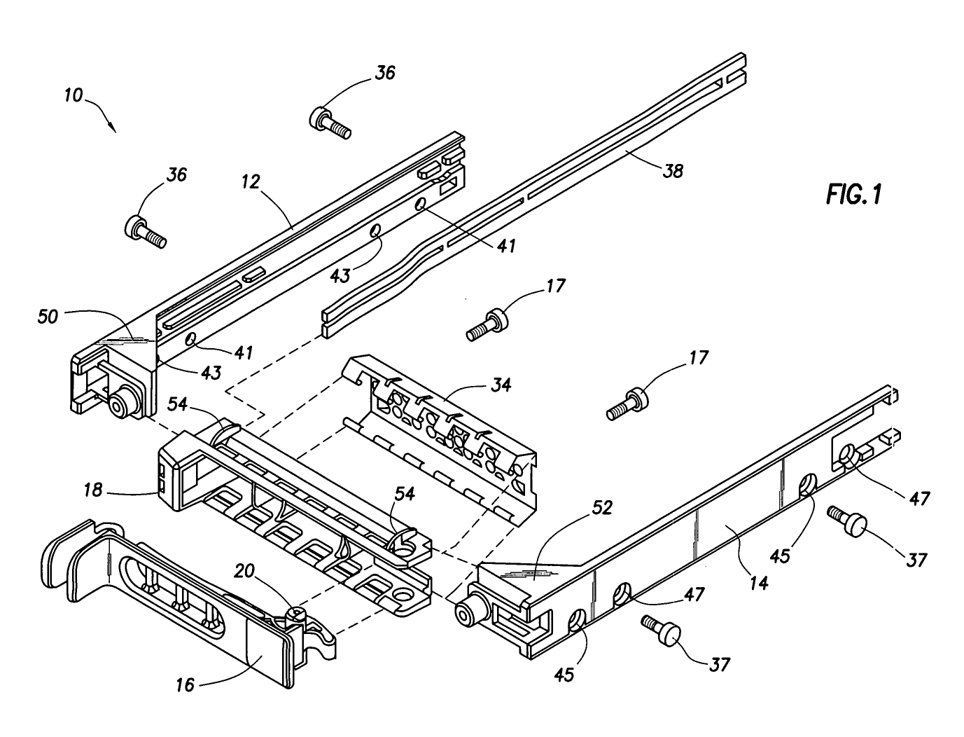

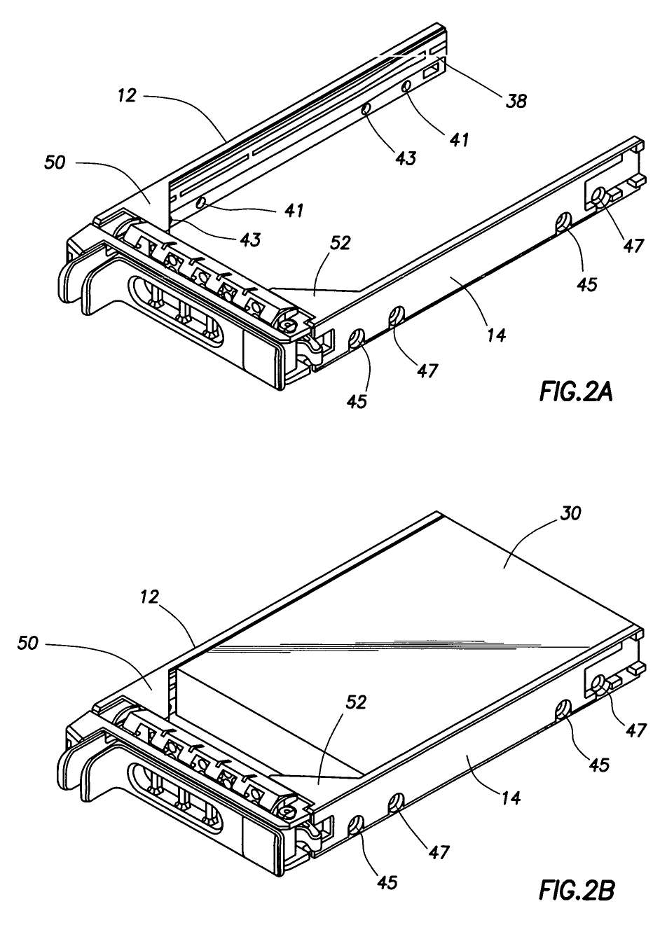

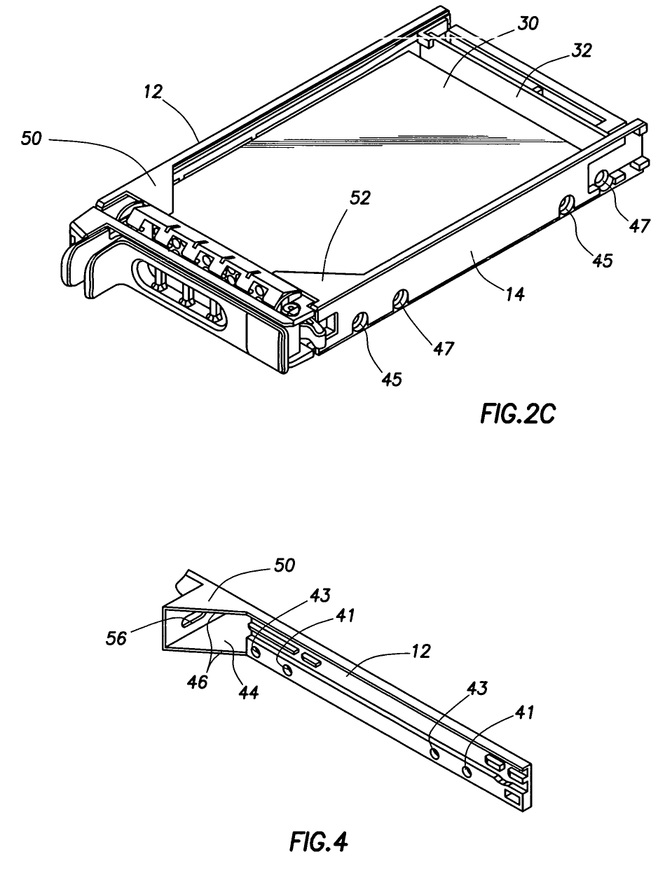

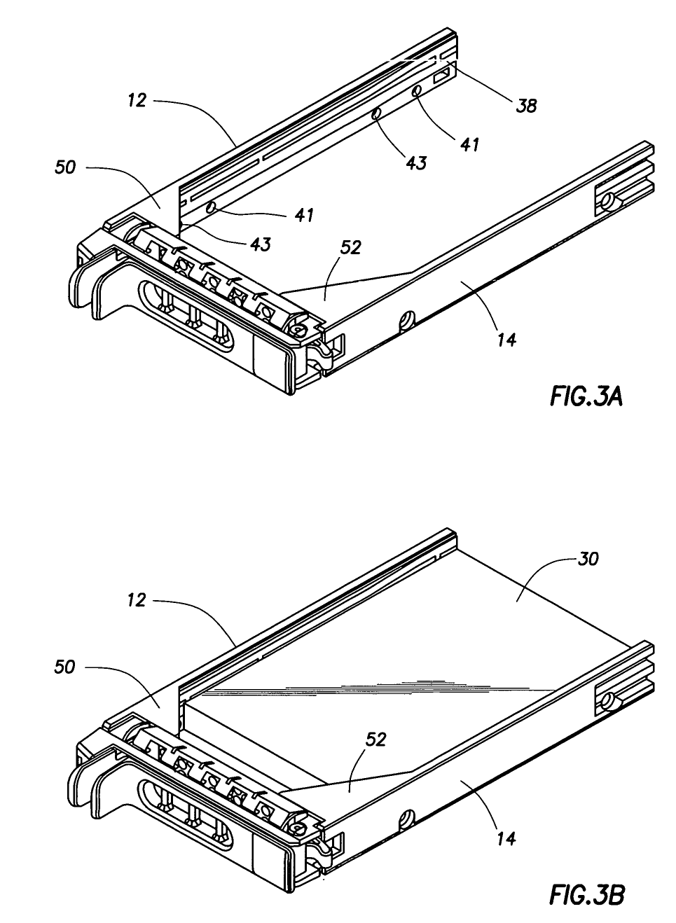

Shown in FIG. 1 is an exploded perspective view of a drive carrier, which is indicated generally at 10. Drive carrier 10 is inserted into a slot in a chassis assembly. Drive carrier 10 is sized to receive a hard drive 30 (shown in FIGS. 2B, 2C, and 3B). Carrier 10 is formed of a top guide rail 12, a bottom guide rail 14, and an EMI shield 34. A latch 16 is coupled to a bezel 18 about a cam lever 20. Bezel 18 is coupled to EMI shield 34, and guide rails 12 and 14, through a pair of thread-forming screws 17. The top guide rail 12 may have a slot 56 (shown in FIG. 4) for receipt of one of the screws 17, instead of a simple circular hole. This allows the top guide rail 12 to be moved inwardly or outwardly from the carrier 10, to accommodate differing widths of hard drives 30. Additionally, variations in setbacks can be accommodated by allowing the latch 16 to bow. Positioned between top guide rail 12 and hard drive 30 is a light pipe 38, which extends along the length of top guide rail 12 and provides for the transmission of diagnostic or operational light signals from the interior of the chassis to the bezel 18 of the hard drive carrier 10.

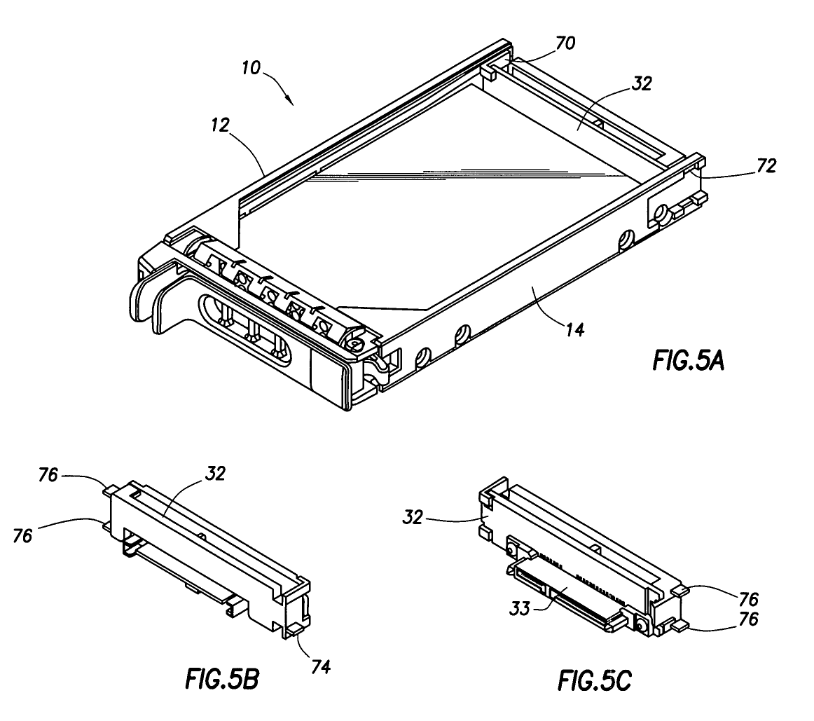

Carrier 10 is sized to optionally receive an interposer 32, (shown in FIG. 2C) which includes a connector 33 (shown in FIGS. 5A-5C). Interposer 32 is connected to the rear connectors of hard drive 30, and is positioned between the top guide rail 12 and the bottom guide rail 14. Due to the height of the EMI shield 34, upon installation, it may extend into space reserved for another carrier. However EMI shield 34 may be made from a flexible material, such that the EMI shield 34 may be slightly deformed when pressure is applied. This helps to ensure a tight fit between carriers. Additionally, the bezel 18 may include wings 54 to protect the EMI shield 34 until deformation is desired.

The hard drive 30 of the hard drive carrier 10 can be positioned in a front or forward position in which the hard drive 30 is closer to the bezel 18, as shown in FIG. 2C. The hard drive 30 of the hard drive carrier 10 can also be positioned in a rear position in which the hard drive 30 is farther away from the bezel 18, as shown in FIG. 2B. Hard drive 30 includes a pair of alignment holes (not shown) for receiving screws 36. To place hard drive 30 in a front or forward position, the alignment holes of hard drive 30 are aligned with a front set of alignment holes 43 in top guide rail 12 and a front set of alignment holes 45 in bottom guide rail 14. To place hard drive 30 in a rear position, the alignment holes of hard drive 30 are aligned with a rear set of alignment holes 41 in top guide rail 12 and a rear set of alignment holes 47 in bottom guide rail 14. Whether hard drive 30 is positioned in a forward position or a rear position, hard drive 30 is secured to top rail guide 12 by a pair of flat head screws 36 that are secured through the respective alignment holes of the top guide rail 12 and hard drive 30. Likewise, whether hard drive 30 is positioned in a forward position or a rear position, hard drive 30 is secured to bottom guide rail 14 by a pair of flat head screws 37 that are secured through the respective alignment holes of the bottom guide rail 14 and hard drive 30.

Top guide rail 12 includes a key 50, which is positioned near the front end of the top guide rail 12 and projects in a downward direction toward the bezel 18. Shown in FIG. 4 is a detailed perspective view of the key 50. For the sake of clarity, some elements of the hard drive carrier 10 are not shown in FIG. 4. Key 50 has a geometry that includes a gap portion 44 lying between two raised portions 46. The key 50 will only allow certain hard drives 30 to be positioned in a forward position in hard drive carrier 10. If the hard drive 30 does not fit within the gap portion 44 in the key 50, due to the height of the hard drive 30 exceeding the height of the gap portion 44, then the hard drive 30 will necessarily be positioned in a rear position in the hard drive carrier 10. Shown in FIG. 2C is an example of a hard drive carrier 10 in which the key 50 is in place and the hard drive 30 is placed in a forward position in which the hard drive is positioned near the bezel 18. In this instance, the height of the hard drive 30 is smaller than height of the gap portion 44, such that the hard drive 30 fits within the gap portion 44. While the top guide rail 12 is discussed herein as having the key 50, the bottom guide rail 14 may also have a similar key 52. Alternatively, the key 52 may be present only in the bottom guide rail 14, with no top key 50. Further, the hard drive carrier 10 may include one type of key 50 on the top guide rail 12, and another type of key 52 on the bottom guide rail 14, as shown in FIGS. 3A and 3B. Since only one key is needed to perform this function, the key 50 in the top guide rail 12 may be adapted to prevent a SAS drive from being placed in a forward position while allowing a SATA drive to be placed in a forward position. When the hard drive 30 is placed in a forward position, hard drive carrier 10 may include the optional interposer 32 as shown in FIG. 2C. In the absence of an interposer 32, hard drive 30 is placed in a rear position and is directly connected to a connector of the chassis, as shown in 3B. When a SATA drive is used without the interposer 32, a different configuration of the bottom rail 14 may be used to ensure proper positioning. This configuration may have key 52 that prevents the hard drive 30, which would otherwise fit in the gap portion 44, from being placed in a forward position. Rather than being placed in a forward position, the key 52 causes the drive 30 to be positioned for direct connection to the connector of the chassis.

The placement of the key 50 permits a hard drive to be placed in one of two positions within the hard drive carrier 10, depending on the height of the hard drive 30. When the height of the hard drive exceeds the height of the gap portion 44, as shown in FIG. 2B, the hard drive 30 may only be placed in a rear position away from bezel 18. In this position, the hard drive 30 is coupled directly to the converter of the chassis. When the height of the hard drive 30 is less than the height of the gap portion 44, the hard drive 30 may be placed in a forward position as shown in FIG. 2C. When the hard drive 30 is in a forward position, the hard drive carrier 10 may also include an interposer.

While the height of the hard drive 30 may exceed the height of the gap portion 44, the height of the hard drive 30 is desirably smaller than the combination of the gap portion 44 and the raised portions 46, such that even if the hard drive 30 does not fit within the gap portion 44, the hard drive remains within confines of the hard drive carrier 10. This allows the guide rails 12 and 14 to protect the hard drive 30 from damage. When the rails 12 and 14 extend beyond the edges of the hard drive 30, a flat surface such as a tabletop is unlikely to cause damage to the hard drive 30, and there is little need for an additional cover over the hard drive 30. While the lack of a cover exposes the surface of the hard drive 30, this exposure may actually help protect the hard drive 30. When the hard drive 30 is uncovered, users tend to be more careful than they may otherwise be. The use of the rails 12 and 14 as high points in the hard drive 30/carrier 10 combination allows the cover to be eliminated, encouraging greater care, while still providing a level of protection for the hard drive 30. Additionally, this allows the carrier 10 to have fewer parts, which reduces time for assembly, as well as cost.

The attachment of the top guide rail 12 to the hard drive 30 also serves to position and fix the light pipe 38 to the hard drive carrier 10. The light pipe 38 of the hard drive carrier 10 is positioned between the top guide rail 12 and the hard drive 30. The attachment of the top guide rail 12 to the hard drive 30 fixes the light pipe 38 to the hard drive carrier 10 without the use of an additional mechanical fixture for the light pipe 38.

Shown in FIGS. 5A-5C are series of pictorial views of the interposer 32 for the hard drive carrier 10. Shown in FIG. 5A is a view of the hard drive carrier 10 and interposer 32, which includes the connector 33 (shown in FIG. 5C). Interposer 32 is sized such that it is received between the top guide rail 12 and the bottom guide rail 14 of the hard drive carrier 10. Hard drive carrier 10 includes a top slot 70 and a bottom slot 72 for receiving interposer 32. Interposer 32 includes an upper tab 74 and a lower tab 76 (shown in FIG. 5B). Upper tab 74 is proximate top slot 70 and lower tab 76 is proximate bottom slot 72. Each of the upper tab 74 and the lower tab 76 may be compliant, allowing the tabs to be canted inward toward the connector 33 for the purpose of attaching or detaching interposer 32 to hard drive carrier 10. Interposer 32 also mates with the connectors of hard drive 30.

FIGS. 5B and 5C depict the interposer 32 in more detail. Upper tab 74 is inserted in top slot 70, which action may cause tab 74 to cant inward in the direction of hard drive 30. To complete the installation of interposer 32 in hard drive carrier 10, lower tab 76 is canted inward and pushed into place in bottom slot 76. Interposer 32 is pushed into place until an audible click is heard, indicating that the lower tab 76 has snapped into place in bottom slot 72. The use of a tab attachment for interposer 32 permits the interposer 32 to be snapped securely in place without the use of screws or any other type of additional mechanical attachment.

Although the present disclosure has been described in detail, it should be understood that various changes, substitutions, and alterations can be made hereto without departing from the spirit and the scope of the invention as defined by the appended claims.

What is claimed is:

1. A hard drive carrier, comprising:
a bezel;
a bottom guide rail; and
a top guide rail, wherein the top guide rail includes a key having a gap portion;
wherein a hard drive fitting within the gap portion may be positioned in the carrier in a forward position relative to the bezel, and a hard drive not fitting within the gap portion may only be positioned in the carrier in a rear position relative to the bezel.

2. The hard drive carrier of claim 1, wherein the key has a geometry comprising:
at least one gap portion between at least two raised portions;
wherein the key is attached to the top guide rail such that access to the gap portion is limited by the presence of the raised portions.

3. The hard drive carrier of claim 1, wherein the top guide rail includes a first set of alignment holes for coupling the hard drive to the hard drive carrier when the hard drive is in the forward position and a second set of alignment holes for coupling the hard drive to the hard drive carrier when the hard drive is in the rear position.

4. The hard drive carrier of claim 1,
wherein the bottom guide rail includes a key having a gap portion; and
wherein a hard drive fitting within the gap portion of the bottom guide rail may be positioned in the carrier in a forward position relative to the bezel, and a hard drive not fitting within the gap portion of the bottom guide rail may only be positioned in the carrier in a rear position relative to the bezel.

5. The hard drive carrier of claim 4, wherein the bottom guide rail includes a first set of alignment holes for coupling the hard drive to the hard drive carrier when the hard drive is in the forward position and a second set of alignment holes for coupling the hard drive to the hard drive carrier when the hard drive is in the rear position.

6. The hard drive carrier of claim 4, wherein the key of the bottom guide rail has a geometry comprising:
at least one gap portion between at least two raised portions;
wherein the key of the bottom guide rail is attached to the bottom guide rail such that access to the gap portion is limited by the presence of the raised portions.

7. The hard drive carrier of claim 1, further comprising:
an interposer, wherein the interposer is operable to be coupled to the connector of a hard drive that is inserted in the hard drive carrier;
wherein the interposer includes a top tab and a bottom tab for coupling the interposer within the hard drive carrier.

8. A hard drive carrier, comprising:
a bezel;
a bottom guide rail; and
a top guide rail, wherein the top guide rail includes a first set of alignment holes for coupling a hard drive to the hard drive carrier when the hard drive is in a forward position relative to the bezel and a second set of alignment holes for coupling the hard drive to the hard drive carrier when the hard drive is in a rear position relative to the position of the bezel.

9. The hard drive carrier of claim 8, wherein the bottom guide rail also includes a first set of alignment holes for coupling the hard drive to the hard drive carrier when the hard drive is in the forward position and a second set of alignment holes for coupling the hard drive to the hard drive carrier when the hard drive is in the rear position.

10. The hard drive carrier of claim 8,
wherein the top guide rail includes a key proximate the bezel;
wherein the key has a gap portion; and
wherein a hard drive fitting within the gap portion may be positioned in the carrier in a forward position relative to the bezel, and a hard drive not fitting within the gap portion may only be positioned in the carrier in a rear position relative to the bezel.

11. The hard drive carrier of claim 10, wherein the key has a geometry comprising:
at least one gap portion between at least two raised portions;
wherein the key is attached to the top guide rail such that access to the gap portion is limited by the presence of the raised portions.

12. The hard drive carrier of claim 10,
wherein the bottom guide rail includes a key proximate the bezel;
wherein the key of the bottom guide rail has a gap portion; and
wherein a hard drive fitting within the gap portion of the bottom guide rail key may be positioned in the carrier in a forward position relative to the bezel, and a hard drive not fitting within the gap portion of the bottom guide rail key may only be positioned in the carrier in a rear position relative to the bezel.

13. The hard drive carrier of claim 12, wherein both the top guide rail key and the bottom guide rail key have a geometry comprising:
at least one gap portion between at least two raised portions;
wherein the keys are attached to the guide rails such that access to the gap portion is limited by the presence of the raised portions.

14. The hard drive carrier of claim 8, further comprising:
an interposer, wherein the interposer is operable to be coupled to the connector of a hard drive that is inserted in the hard drive carrier;
wherein the interposer includes a top tab and a bottom tab for coupling the interposer within the hard drive carrier.

15. A hard drive carrier, comprising:
a bottom guide rail; and
a top guide rail, wherein the top guide rail includes a key;
wherein a hard drive fitting within the key may be positioned within the key, and a hard drive not fitting within the key may only be positioned beyond the key.

16. The hard drive carrier of claim 15, wherein the key has a geometry comprising:
at least one gap portion between at least two raised portions;
wherein the key is attached to the top guide rail such that access to the gap portion is limited by the presence of the raised portions.

17. The hard drive carrier of claim 15, wherein the top guide rail includes a first set of alignment holes for coupling the hard drive to the hard drive carrier when the hard drive is positioned within the key and a second set of alignment holes for coupling the hard drive to the hard drive carrier when the hard drive is positioned beyond the key.

18. The hard drive carrier of claim 15,
wherein the bottom guide rail includes a key; and
wherein a hard drive fitting within the key of the bottom guide rail may be positioned within the key of the bottom guide rail, and a hard drive not fitting within the key of the bottom guide rail may only be positioned beyond the key of the bottom guide rail.

19. The hard drive carrier of claim 18, wherein the bottom guide rail includes a first set of alignment holes for coupling the hard drive to the hard drive carrier when the hard drive is positioned within the key of the bottom guide rail and a second set of alignment holes for coupling the hard drive to the hard drive carrier when the hard drive is positioned beyond the key of the bottom guide rail.

20. The hard drive carrier of claim 18, wherein the key of the bottom guide rail has a geometry comprising:
at least one gap portion between at least two raised portions;
wherein the key of the bottom guide rail is attached to the bottom guide rail such that access to the gap portion is limited by the presence of the raised portions.
